(19) United States
(12) Patent Application Publication
(10) Pub. No.: US 2003/0210281 A1
(43) Pub. Date: Nov. 13, 2003

(54) Magnifying a thumbnail image of a document

(76) Inventors: Troy Ellis, Star, ID (US); Kristin Smith, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/141,666

(22) Filed: May 7, 2002

(51) Int. Cl. G09G 5/00

(52) U.S. Cl. 345/838

(57) ABSTRACT

Systems and methods for managing documents in a software application and for viewing an image of a document are disclosed herein. A method for viewing an image comprises a step of creating reduced-size images, hereinafter referred to as thumbnail images, of documents displayed in a document window. For text documents, the thumbnail images are miniature views of the first page of the text documents. When the thumbnail images have been created, the method further comprises a step of converting the software application from a normal operating mode to a magnifying mode. During the magnifying mode, one of the thumbnail images may be selected and magnified to reveal the contents of the document. The selected thumbnail image may be magnified without opening the document.

### TECHNICAL FIELD OF THE INVENTION

The present invention is generally related to the management of text and image documents. More particularly, the present invention is related to systems and methods for magnifying thumbnail images of text and image documents.

### BACKGROUND OF THE INVENTION

Computer users commonly utilize software applications to create and store documents or files. For instance, using graphic software, a user may create and store image documents in a number of graphic file formats such as .bmp, .gif, .jpg, etc. Using data processing software, a user may create and store text documents in a number of text file formats such as .txt, .doc, etc. Some software applications may use both graphic and text software, thereby allowing image documents and text documents to be stored and managed in the same application. For example, the HP LaserJet 3200 is a multi-function printing tool having the capability to print, copy, fax, and scan. The accompanying software for the HP LaserJet 3200, i.e. the Document Manager software application, is used to control the operations of-the printing tool and to manage the image and text documents that were created during operation of the printing tool.

In the management of documents, software packages typically use icons with the document names to visually represent the file format of the document. For example, a document having a Microsoft Word format is typically represented by an icon of a piece of paper with a “W” superimposed. Typically the icon has a certain size and is positioned with respect to the document name. For example, the icon may be the same size as the font size of the document name and placed to the left of the document name, or it may be enlarged and placed above the document name. Although the icon is a good representation of the file format of the document, it may be difficult for a user to distinguish one document from another since documents of the same format have the same icon representation. Furthermore, the user may not be able to distinguish one document from another if the names given to the documents are similar to each other or if the names are non-descriptive.

To help distinguish one document from another, it may be helpful to utilize a software application that is capable of providing a miniature image, hereinafter referred to as a “thumbnail image,” of the document. Thumbnail images, which are commonly used to show images of graphic documents, may also be used to show a portion of text documents. For instance, the software application may show a thumbnail image of the first page of the text document so that the user may more easily identify a specific document.

Although thumbnail images of text documents may be useful in most situations, some situations may still arise wherein text documents are difficult to distinguish from each other. For instance, when the first page of several text documents have a similar page layout or appearance, a thumbnail image typically will not be able to, show enough detail. Thus, it may still be difficult for a user to make a distinction between the documents. Accordingly, a need exists in the industry to address the aforementioned deficiencies and inadequacies to allow a user to more easily make a distinction between a group of documents in document management applications.

### SUMMARY OF THE INVENTION

Disclosed herein are systems and methods for viewing an image of a document that is stored in a computer system. One disclosed method comprises a step of creating a thumbnail image of a document, wherein the thumbnail image is a reduced-size view of a portion of the contents of the document. When the thumbnail image is created, the method comprises a step of converting or changing the operation of a document management application from a normal operating mode to a magnifying mode. In the magnifying mode, the thumbnail image may be magnified. Optionally, the method may further comprise magnifying the thumbnail image without opening the document.

Also disclosed is a computer program and document manager for viewing an image of a document stored in a computer system. In one embodiment, the computer program and document manager comprise logic configured to create thumbnail images of a portion of the contents of the document, logic to initiate a magnifying mode, and logic configured to magnify the thumbnail image. The logic configured to magnify the thumbnail image may further comprise magnifying the thumbnail image without opening the document. The computer program and document manager may further comprise logic configured to create a plurality of thumbnail images corresponding to a plurality of documents.

Also disclosed is a document managing system, which comprises means for accessing documents stored in a computer and means for displaying the documents in a window. The document managing system further comprises means for creating thumbnail images of the documents in the window and means for magnifying one of the thumbnail images.

### BRIEF DESCRIPTION OF THE DRAWINGS

Many aspects of the invention can be better understood with reference to the following drawings. Like reference numerals designate corresponding parts throughout the several views.

FIG. 1 is a block diagram of an example embodiment of a memory component.

FIG. 2 is a view of an embodiment of a main screen shown during execution of an example document management application or stand-alone application in which a thumbnail magnifying command operates.

FIG. 3 is a view of an embodiment of a File menu accessed during execution of the example application shown in FIG. 2.

FIG. 4 is a view of an example window of an Open command accessed through the File menu of FIG. 3.

FIG. 5 is a view of an embodiment of a Tools menu accessed during execution of the example application shown in FIG. 2.

FIG. 6 is a view of an embodiment of a View menu accessed during execution of the example application shown in FIG. 2.

FIG. 7 is a view of an embodiment of a Views menu accessed from the standard buttons toolbar shown in FIG. 2.

FIG. 8 is a view illustrating an example of a right-mouse-click window accessed during use of the example document manager shown in FIG. 1.

FIG. 9 is a view illustrating another example of a right-mouse-click window accessed during use of the example document manager shown in FIG. 1.

FIG. 10 is a view of an embodiment of the main screen shown in FIG. 2 during the magnification of a thumbnail image.

FIG. 11 is a view of an embodiment of the main screen shown in FIG. 2 during an alternative magnifying mode.

### DETAILED DESCRIPTION OF THE INVENTION

Systems and methods for magnifying thumbnail images of text and image documents are disclosed herein. Text and image documents may be managed in various software applications, such as, for example, the Document Manager software, which is used in conjunction with the HP LaserJet 3200 printing tool. The thumbnail image magnifying systems and methods of the present disclosure may be incorporated in this or other document management software. Alternatively, the thumbnail image magnifying systems and methods may be configured as a stand-alone application that operates in software applications where documents are stored or accessed. When used as a standalone application, the thumbnail image magnifying systems and methods may be initiated by clicking on an icon, located, for instance, in the system tray.

The thumbnail image magnifying systems and methods may create a magnified version of a thumbnail image in one step or by first creating thumbnail images of available documents and then magnifying a selected thumbnail image. Thumbnail images may be created by a thumbnail creator, which displays a miniature view of each document available in a particular document window. Once the thumbnail images are created, a magnifier may be utilized to increase the size of the miniature thumbnail view to an intermediate size that is large enough for the user to be able to distinguish between documents having similar thumbnail images.

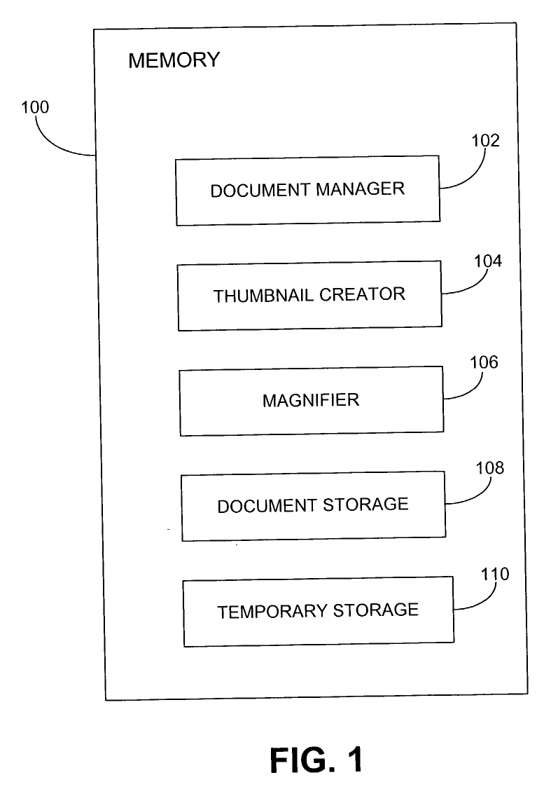

FIG. 1 is a block diagram of memory 100 that may be incorporated in a computer system. The memory 100 can include any one or combination of volatile memory elements (e.g., random access memory (RAM), dynamic RAM (DRAM), synchronous DRAM (SDRAM), static RAM (SRAM), etc.) and nonvolatile memory elements (e.g., read-only memory (ROM), hard drive, tape, compact-disk ROM (CDROM), etc.). Moreover, the memory 100 may incorporate electronic, magnetic, optical, and/or other types of storage media. Note that the memory 100 can have a distributed architecture, where various components are situated remote from one another, but can be accessed by the processor of the computer.

The memory 100 may comprise at least a document manager 102, a thumbnail creator 104, a magnifier 106, document storage 108, and temporary storage 110. The document manager 102 may be any one of a number of software applications (e.g. Windows Explorer, HP LaserJet Document Manager, etc.) that allows a user to manipulate files or documents by performing such functions as copy, delete, open, rename, find, etc.

The memory 100 may also comprise a thumbnail creator 104 that is capable of creating thumbnail images of documents stored in document storage 108. The thumbnail creator 104 may additionally create thumbnail images as documents are created in or imported into the computer system. The thumbnail creator 104 may utilize temporary storage 1 10 within memory 100 for temporarily storing thumbnail images of documents as the documents are accessed by the computer system. In order to avoid a situation wherein a large volume of memory is dedicated to temporary storage I 10, it may be desirable that the thumbnail creator 104 store in temporary storage 110 those documents that are being accessed or those that have been accessed within a certain timeframe. It may be desirable that the temporary storage 110 comprise a First In, First Out (FIFO) register that is capable of storing a limited number of images. In addition to the thumbnail images of the accessed documents, the thumbnail creator 104 may also create intermediate images of documents, such that the intermediate images are of a size between a full-sized image of the document and the thumbnail image of the document. The thumbnail creator 104 typically creates a intermediate image from the document itself so as to ensure adequate resolution. In addition, the thumbnail creator 104 typically creates the intermediate images large enough so that a user may easily determine the contents of a portion of the document by observing the intermediate image. The intermediate images, like the thumbnail images, may also be stored in temporary storage 110.

The memory 100 may also comprise a magnifier 106, which may include a software application for magnifying a thumbnail image. The magnifier 106 may be capable of magnifying a thumbnail image created by the thumbnail creator 104 or an image created externally. In the embodiment where a thumbnail image is created externally and no intermediate image is available, the magnifier 106 may comprise software or circuitry for creating intermediate images. In this case, the magnifier 106 creates an intermediate image from the original document. By creating the intermediate image from the original document, the resolution of the intermediate image is typically viewable with relative ease, as opposed to an image magnified from a lower resolution thumbnail image.

The memory 100 may be configured such that the document manager 102 includes the thumbnail creator 104 and the magnifier 106 therein. In such a case, the document manager 102 would be capable of accessing documents stored in memory 100, creating thumbnail images of the accessed documents using the thumbnail creator 104, and magnifying one or more of the thumbnail images using the magnifier 106. Alternatively, the elements in memory 100 may be stored separately as shown in FIG. 1. In this alternative embodiment, the thumbnail creator 104 and/or the magnifier 106 may be implemented in a stand-alone application separate from the document manager 102. The stand-alone application may be incorporated into a computer system such that the application may be accessed upon demand. The stand-alone application may include an icon placed on the desktop of a computer system, in the system tray, on a toolbar, or on any combination thereof. The thumbnail creator 104 and magnifier 106 may be formed together as one software application to allow the creating of thumbnail images and magnifying of the thumbnail images in one application.

The thumbnail creator 104 and magnifier 106 of the present disclosure can be implemented in hardware, software, firmware, or a combination thereof. In the disclosed embodiments, the thumbnail creator 104 and magnifier 106 described herein is implemented in software or firmware that is stored in a memory 100 and that is executed by a suitable instruction execution system. If implemented in hardware, as in an alternative embodiment, the thumbnail creator 104 and magnifier 106 can be implemented with one or a combination of the following technologies, which are all well known in the art: a discrete logic circuit having logic gates for implementing logic functions upon data signals, an application specific integrated circuit (ASIC) having appropriate combinations of logic gates, a programmable gate array (PGA), a field programmable gate array (FPGA), etc.

The above-described thumbnail creator 104 and magnifier 106 can be embodied in a program comprising an ordered listing of executable instructions for implementing logical functions. The program can be embodied in any computer-readable medium for use by an instruction execution system, apparatus, or device, such as a computer-based system, processor-controlled system, or other system that can fetch the instructions from the instruction execution system, apparatus, or device and execute the instructions. In the context of this document, a “computer-readable medium” can be any medium that can contain, store, communicate, propagate, or transport the program for use by the instruction execution system, apparatus, or device. The computer-readable medium can be, for example, an electronic, magnetic, optical, electromagnetic, infrared, or semiconductor system, apparatus, device, or propagation medium. More specific examples of the computer-readable medium include the following: an electrical connection having one or more wires, a portable magnetic computer diskette, a random access memory (RAM), a read-only memory (ROM), an erasable programmable read-only memory (EPROM or Flash memory), an optical fiber, and a portable compact disc read-only memory (CDROM). Note that the computer-readable medium could even be paper or another suitable medium upon which the program is printed, as the program can be electronically captured, for instance, by optical scanning of the paper or other medium, then compiled, interpreted or otherwise processed in a suitable manner if necessary, and then stored in a computer memory. In addition, the scope of the present invention includes embodying the functionality of the embodiments of the present disclosure in logic embodied in hardware or software-configured mediums.

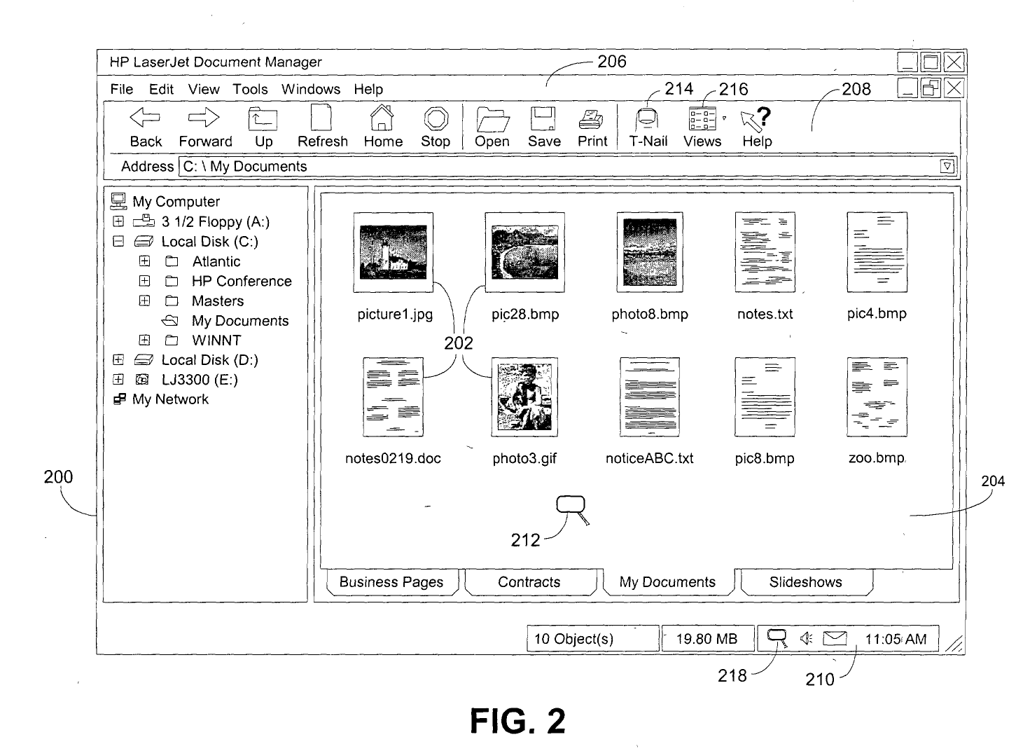

FIG. 2 is a view of an embodiment of a main screen 200 of an example document manager 102 operating in a format including windows. FIG. 2 illustrates a thumbnail viewing mode, wherein the thumbnail images 202 of the accessible documents are displayed in a document window 204. It should be noted that the document window 204 of the main screen 200 contains several accessible documents. Some of the documents are shown as graphic documents, wherein each thumbnail image of the graphic documents is a miniature image of the document. Other documents may be text documents, wherein each thumbnail image of the text documents is a miniature image of a portion of the contents of the document. The portion of the contents of the document may include, for instance, the first page of the text document. Alternatively, it may be desirable to allow a user to choose a page other than the first page of a text document as the page that is displayed as the thumbnail image. In this alternative embodiment, the user may choose a page that may be more easily identified from a number of other similarly created text documents.

To create the thumbnail images 202, the thumbnail creator 104 may form the thumbnail images 202 having a size that is appropriate to allow multiple documents to be shown at a time within the document window 204. For instance, the size of the thumbnail images 202 may be approximately ⅙ of the size of the full-sized documents. Then, the thumbnail creator 104 or document manager 102 may place the name of each document below the respective thumbnail image. Alternatively, the thumbnail creator 104 or document manager 102 may place the document names above or beside the thumbnail images.

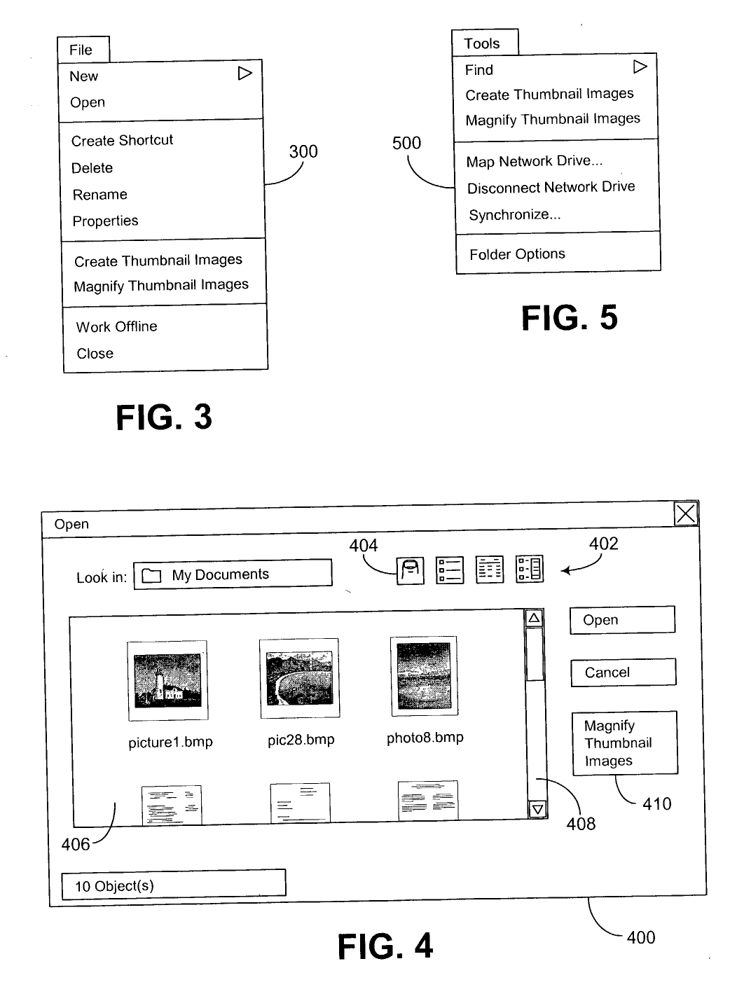

The user may designate the thumbnail-viewing mode as a default mode so that the thumbnail images of the accessible documents are shown upon starting the document manager 102. On the other hand, if the document manager displays the document names in a format other than with thumbnail images and if the user desires to view the thumbnail images, the user may request to view the thumbnail images by utilizing various techniques. For example, FIGS. 3-8 demonstrate several possible ways that a user may request the thumbnail-viewing mode.

Initiating the Thumbnail Viewing Mode

One way that the user may view the thumbnail images is illustrated in FIG. 3, which shows a view of a File menu window 300 that may be opened by selecting “File” in the command toolbar 206 shown in FIG. 2. The File menu window 300 may include in its menu list commonly known commands, such as New, Open, and Delete, just to name a few. In addition to the common commands, additional commands may be accessible from this menu. A command with a title such as “Create Thumbnail Images” may be incorporated into the File menu to allow a user to select the display of accessible documents in the document window 204 as a display showing thumbnail images of each of the documents. The act of selecting may be accomplished by a user clicking on the commands or buttons using a mouse. Selection may also be made by other alternative means.

FIG. 4 illustrates another way in which the thumbnail viewing mode may be accessed. When a user clicks on the File command in the command toolbar 206 shown in FIG. 2 to access the File menu window 300 of FIG. 3, and then clicks on the Open command shown in FIG. 3 to open an existing file, an Open window 400 as illustrated in FIG. 4 may appear. The Open window 400 may include buttons 402 near the upper right corner of the Open window 400 that may be selected to change the visual format of the documents. When the user clicks on a “Thumbnail” button 404, the thumbnail images of the accessible documents appear within the document window 406 in the middle of the Open window 400. If the thumbnail images and corresponding document names do not fit within the document window 406, a well-known scrolling mechanism 408 may be used to access documents located outside the pane of the document window 406. A similar scrolling mechanism may be used with respect to the document window 204 shown in FIG. 2 when the documents more than fill the document window 204.

FIG. 5 illustrates an alternative way of requesting the thumbnail viewing mode. By clicking on the Tools command in the command toolbar 206 shown in FIG. 2, a Tools menu window 500 opens to reveal a menu of “Tools” commands. The user may view the thumbnail images of the accessible documents by clicking a “Create Thumbnail Images” command. When this command is selected, the thumbnail images are created as described above.

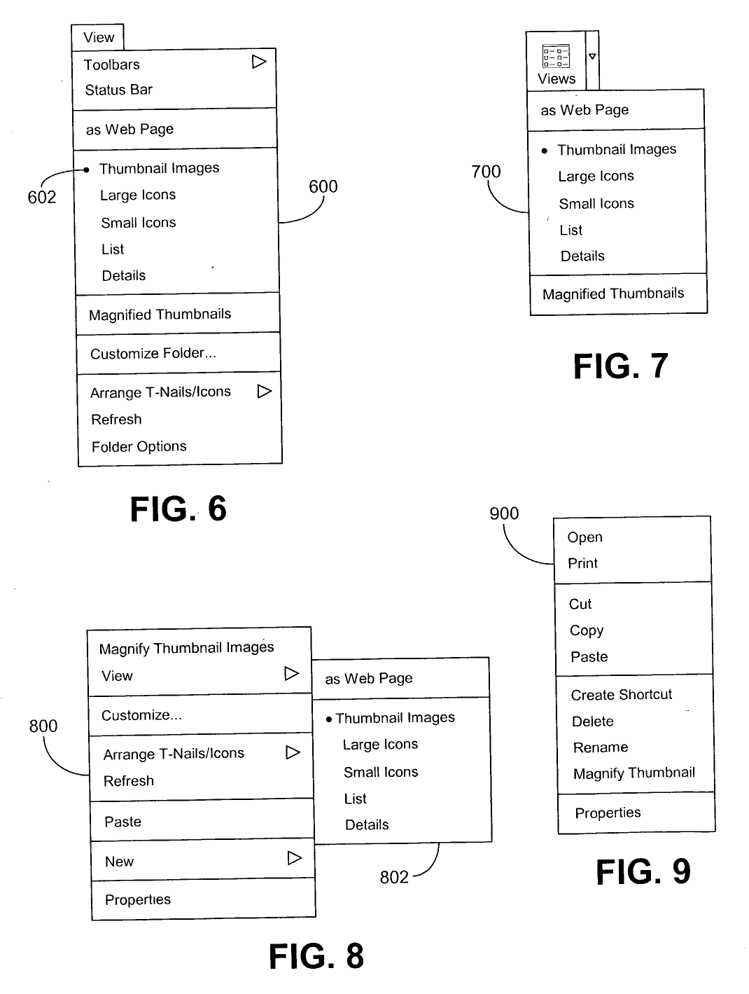

FIG. 6 shows an example of a View menu window 600 that may be opened by clicking on the View command from the command toolbar 206 shown in FIG. 2. The View menu window 600 may comprise a menu of commands and choices for viewing the toolbars and windows on the main screen 200. The menu may comprise choices as to how the accessible documents are displayed, such as common choices including Large Icons, Small Icons, List, and Details. In addition to the common choices, the View menu may also include a “Thumbnail Images” choice. To select Thumbnail Images, the user clicks on “Thumbnail Images,” and the thumbnail creator 104 changes the display of documents to show the document name with the thumbnail image placed adjacent to the document name. Furthermore, the thumbnail creator 104 places a bullet 602 to the left of the selected choice to indicate to the user which choice has been selected. Indicators other than the bullet 602 may be used to indicate the viewing selection.

Another example embodiment wherein the thumbnail viewing mode may be requested includes clicking a button in the standard buttons toolbar 208 shown in FIG. 2. The standard buttons toolbar 208 may comprise a “T-Nail” button 214, which may be clicked to change the way the documents are displayed. The T-Nail button 214 may be clicked to toggle between a thumbnail viewing mode and a regular viewing mode, which may comprise the documents shown with large icons, small icons, lists, or details.

Alternatively, the standard buttons toolbar 208 may comprise a “Views” button 216. When the user clicks the Views button 216, the choice of views is changed to the next view in the menu list. The order of items in the menu list may be arbitrary. However, in this example, the list includes five items: Thumbnail Images, Large Icons, Small Icons, List, and Details. After the last choice, i.e. the Details view, the first choice, i.e. the Thumbnail Images view, is accessed. Alternatively, the Views button 216 may comprise a Views drop-down menu window 700, as shown in FIG. 7, accessed by a down arrow to the right of the Views button. By clicking on the down arrow, the drop-down menu window 700 is displayed. From this menu, one of the different document-viewing modes may be selected. To request the thumbnail viewing mode, the user clicks the “Thumbnail Images” command, and the thumbnail images are created as described above.

FIG. 8 illustrates an embodiment of a window 800 that may be accessed by a right-mouse-click in the empty space between the documents in the document window 204 shown in FIG. 2. From window 800, the user may click on View to access a side window 802 that offers the “Thumbnail Images” choice to view the thumbnail images of the documents. If this choice is selected, the thumbnail images are created.

Various example techniques for initiating the thumbnail-viewing mode have been described. However, when the documents are displayed in the thumbnail viewing mode as illustrated in FIG. 2 by the manner described with respect to FIGS. 3-8 above, the user still may not be able to distinguish one document from another if the documents appear to be the same when viewed as thumbnail images. In the example shown in FIG. 2, for instance, it may be difficult to distinguish between the documents pic4.bmp and pic8.bmp because the thumbnail images of these documents contain text at substantially the same location on the page. The prior art solution to distinguishing between the two documents would entail opening each document and reading the contents thereof. However, the present disclosure defines systems and methods wherein a distinction between documents having similar thumbnail views can be made without opening the files. By initiating a Magnify mode, as will be explained below, the user may magnify a thumbnail image to a size that reveals more details of the document, thereby allowing the user to quickly determine the contents of the document without having to open the document.

To initiate the Magnify mode, the user may use any one of a number of routes, as will be explained with reference again to FIGS. 3-8 and also with reference to FIG. 9. Other alternatives to the examples shown in FIGS. 3-9 may be incorporated into the magnifier 106 to request the Magnify mode. When the Magnify mode is requested, the magnifier 106 may change the document manager 102 from a normal mode of operation to a Magnify mode, thereby allowing a user to select a thumbnail image or a portion of a thumbnail image for magnification. When the Magnify mode is initiated, the mouse pointer may be changed to a shape that is indicative of the Magnify mode. For instance, the mouse pointer shape during the Magnify mode may be changed to a miniature magnifying glass image, to a large magnifying glass image, or to some other image to distinguish the Magnifying mode from a normal mode.

Initiating the Magnifying Mode

The present disclosure may include embodiments of systems wherein the Magnify command is available without the documents being in the thumbnail-viewing mode. In these embodiments, the user may request a Magnify command that may, in one step, place the documents in the thumbnail viewing mode and initiate the Magnify mode, thereby allowing the user to view magnified thumbnail images without beforehand creating the thumbnail images as is described above.

Alternatively, embodiments may include systems wherein the Magnify command is accessed when the documents are first shown in the thumbnail viewing mode. In these alternative embodiments, the document manager 102 may disable the Magnify mode when not in the thumbnail viewing mode, and may change the command buttons used for requesting the Magnify mode to phantom text to indicate that the Magnify mode is not available. In this example, when the documents are not shown in the thumbnail view format, then the Magnify command is not available until the thumbnail viewing mode is selected. When the documents are shown in the thumbnail viewing mode, the document manager 102 enables the magnifier 106 and signals the enabling of the Magnify mode by changing the phantom text to regular solid text.

With respect to FIG. 3, the File menu window 300 of FIG. 3 may comprise a “Magnify Thumbnail Images” command. When the user clicks this command, the magnifier 106 changes the mouse pointer to indicate being in the Magnify mode and goes into the Magnify mode allowing the magnification of the thumbnail images.

FIG. 4 illustrates the embodiment of the Open window 400, accessed by selecting the File command shown in FIG. 2 and selecting the Open command in the File menu window 300 shown in FIG. 3. In the Open window 400, a “Magnify Thumbnail Images” button 410 may be included. When the user selects button 410, the document window 406 in the Open window 400 goes into the Magnify mode allowing the user to magnify a selected thumbnail image. The Magnify command may be especially useful when the user is preparing to open a document. In order that the user may easily identify the document that is to be opened, the user may initiate the Magnify command to view the first page of a document in question. Therefore, any documents that may have thumbnail images that appear to be the same may be quickly identified and distinguished from each other.

In FIG. 5, the Tools menu window 500 is shown having a “Magnify Thumbnail Images” command. The user may click this command to put the document manager 102 into the Magnify mode.

FIGS. 6 and 7 illustrate the View menu window 600 and Views drop-down menu window 700, respectively. The View menu window 600 and drop-down menu window 700 may have similar menu options. For instance, both may have a command to view “Magnified Thumbnails” which places the document manager 102 in the Magnify mode.

Another example of how the Magnify mode may be initiated is shown in FIG. 8. When a user right mouse clicks on an empty space that is not reserved for any document, the window of FIG. 8 opens, showing possible options. One such option is a “Magnify Thumbnail Images” option, which puts the document manager 102 in the Magnify mode.

Other techniques and procedures may be used other than the techniques and procedures described with respect to FIGS. 3-8 to place the document manager 102 in a Magnify mode. For example, a stand-alone application comprising the magnifier 106 as shown in FIG. 1 may be stored in the computer. In such a case, an icon 218 such as a magnifying glass image, for example, may be placed in the system tray 210 as shown in FIG. 2. By clicking on the magnifying glass icon 218 in the system tray 210, the stand-alone application may then be accessed.

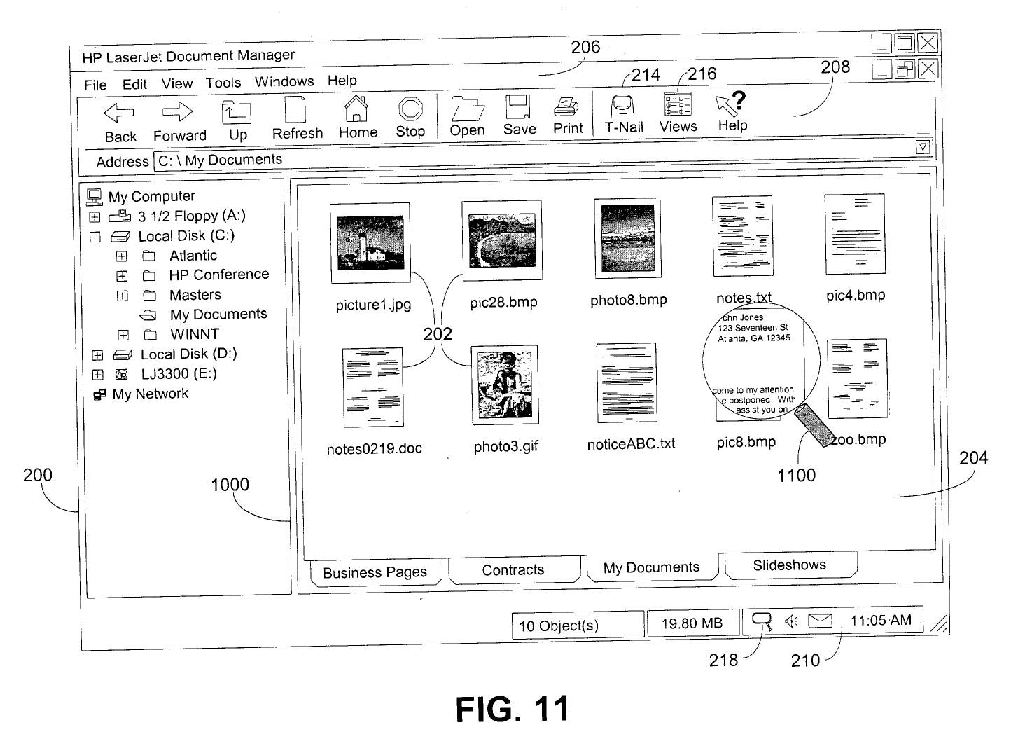

Regardless of how the Magnify mode is initiated, the magnifier 106 may give some indication that the document manager 102 is in the Magnify mode. For example, the magnifier 106 may change the appearance of the mouse pointer displayed in the document manager 102 to an appropriate shape to indicate that the Magnify mode has been requested. See, for example, FIG. 2 wherein a magnifying glass mouse pointer 212 is shown in the document window 204, thereby indicating being in the Magnify mode. FIG. 11 illustrates an alternative embodiment wherein the mouse pointer is changed to a large magnifying glass mouse pointer 1100. The embodiment of FIG. 11 will be described in more detail below. In addition to being displayed in the document window 204, the magnifying glass mouse pointer 212 and the large magnifying glass mouse pointer 1100 may also be displayed in other document windows, e.g., the document window 406 in the Open window 400 shown in FIG. 4.

Magnifying Thumbnail Images

The thumbnail images 202 may be magnified using a variety of possible techniques, including some possible embodiment as described below. The thumbnail images 202 may be magnified without the document manager 102 being in the Magnify mode. For example, FIG. 9 illustrates an embodiment for creating the magnified view of the thumbnail image. Instead of initiating the Magnify mode as explained with respect to FIGS. 3-8, wherein a magnifying glass mouse pointer 212 or 1100 is shown, FIG. 9 provides a way to magnify a thumbnail image 202 without going into the Magnify mode. A user may simply right-mouse-click on a thumbnail image 202 to bring up the menu window 900 shown in FIG. 9. One command in the menu window 900 may be a “Magnify Thumbnail” request, which triggers the magnifier 106 to magnify the thumbnail image 202 of this particular document.

Several examples, as explained below, pertain to magnifying the thumbnail images while the document manager 102 is in the Magnify mode. One technique may involve the user simply moving the magnifying glass mouse pointer 212 over a thumbnail image 202 of a particular document of interest. The magnifier 106 may comprise delay circuitry or software for delaying the magnification of the thumbnail image 202. It may be desirable to provide the delay in order that, when the user sweeps the magnifying glass mouse pointer 212 across the document window 204, the thumbnail images along the path of the sweep are not magnified until after a delay. In such a case, the delay would prevent the images from quickly magnifying and reducing, causing a visually disturbing sight. Thus, the magnifier 106 may wait until the mouse pointer 212 stops moving or until a time delay has expired. The time delay may be set at about one second or may be a changeable option set by the user. After the mouse pointer 212 has been held over the selected thumbnail image for the predetermined delay, the magnifier 106 retrieves the intermediate image of the selected document from temporary storage 110 and displays the intermediate image on the main screen 200. The intermediate image may be “un-magnified” or reduced in size to the size of the thumbnail image simply by moving the mouse pointer 212 away from the location of the selected thumbnail image.

In an alternative technique for magnifying an individual thumbnail image 202, the magnifier 106 may magnify the thumbnail image 202 when the user clicks on the selected thumbnail image 202. This embodiment may be desirable to prevent unwanted magnified images from popping up and getting in the way of the user's view of the other thumbnail images 202. When the selected thumbnail is clicked in this example, the magnifier 106 retrieves the intermediate image from temporary storage 110 and displays the intermediate image on the main screen 200.

When a thumbnail image is selected for magnification, the magnifier 106 may magnify the image by gradually increasing the size of the image starting at the size of the thumbnail image and ending at the size of the intermediate image. Alternatively, the magnifier 106 may magnify the thumbnail image to the size of the intermediate image substantially instantaneously.

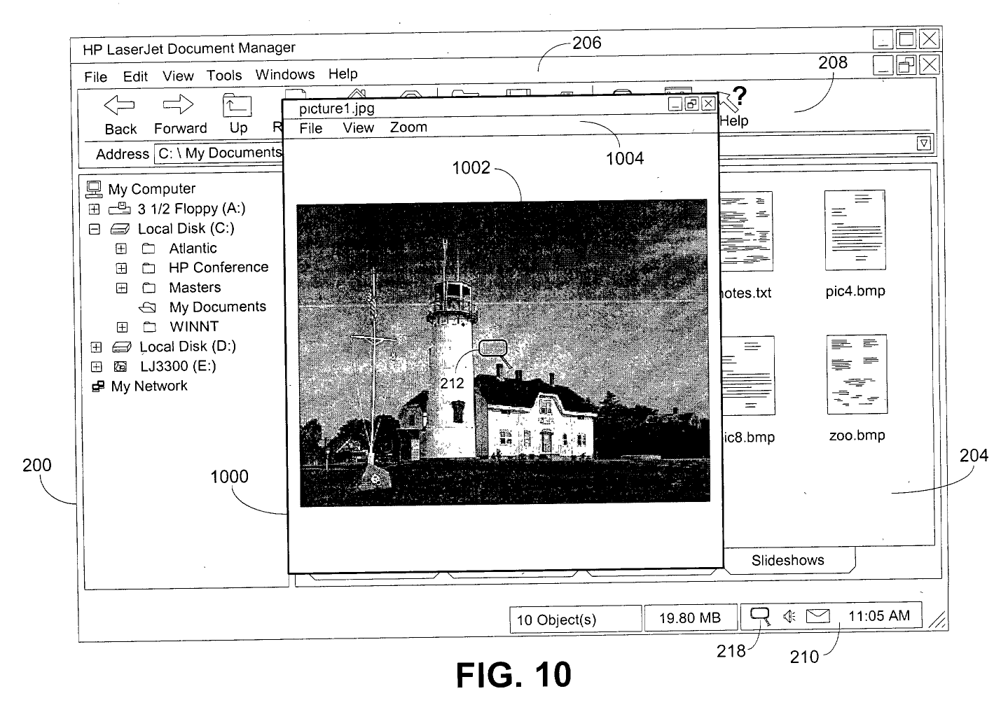

FIG. 10 is a view of an example embodiment of a screen wherein the magnified thumbnail image, or intermediate image, is shown. The magnifier 106 may open a magnified image window 1000 encompassing the intermediate image 1002. The magnified image window 1000 may have the typical characteristics of a window that may be minimized, restored, or closed. In addition, the magnified image window 1000 may include a zooming capability that may be accessed by clicking on the Zoom command in the toolbar 1004. The Zoom command may include menu items allowing the user to increase or decrease the zooming factor of the image. The zooming capability may be useful in cases where the user's monitor does not have adequate resolution to read or view the intermediate image, which typically is smaller than the size of the original document.

The user may also access View commands by clicking “View” in the toolbar 1004. A View menu window (not shown) may include options for viewing the image, such as options for adjusting color, contrast, etc.

Alternative to the opening of the magnified image window 1000 to display the magnified image, the magnifier 106 may produce a magnified image that fills the entire main screen 200. In such a case, the thumbnail creator 104 or magnifier 106 creates a larger intermediate image having the dimensions of the entire main screen 200. The larger intermediate image may be stored in temporary storage 110 and retrieved from temporary storage 110 upon request. In this embodiment, the magnified image may be reduced back to the size of the thumbnail image simply by clicking on the magnified image.

FIG. 11 is a view of the main screen 200 wherein an alternative embodiment may be initiated. The magnifier 106 may be configured to display a large magnifying glass mouse pointer 1100 in response to a request for the Magnify mode. In this embodiment, the user may manipulate the large magnifying glass mouse pointer 1100 over the thumbnail images 202 in the document window 204. The magnifier 106, in real time, displays the portion of the one or more thumbnail images 202 over which the large magnifying glass mouse pointer 1100 is positioned. When the user moves the large magnifying glass mouse pointer 1100 over different portions of the thumbnail images 202, the magnified view changes to reflect the movement. In this embodiment, the large magnifying glass mouse pointer 1100 has a size that is sufficiently large to allow the user to view enough of the selected thumbnail image to easily determine the contents of the document.

It should be emphasized that the above-described embodiments of the-present invention are merely examples of possible implementations, set forth for a clear understanding of the principles of the invention. Many variations and modifications may be made to the above-described embodiments of the invention without departing from the principles of the invention. All such modifications and variations are intended to be included herein within the scope of this disclosure and protected by the following claims.

We claim:

1. A method for viewing an image of a document, the method comprising the steps of:
creating a thumbnail image of a portion of the contents of a document stored in a document management application;
converting the document management application from a normal operating mode to a magnifying mode; and
magnifying the thumbnail image to reveal the portion of the contents of the document.

2. The method of claim 1, wherein the document is a text document.

3. The method of claim 2, wherein the portion of the contents of the document is a first page of the document.

4. The method of claim 3, wherein the thumbnail image is a reduced-size view of the first page of the text document.

5. The method of claim 1, further comprising the step of converting the document management application from the magnifying mode back to the normal operating mode.

6. The method of claim 1, wherein the step of creating comprises creating a thumbnail image for each of a plurality of documents located in a document window of the document management application.

7. The method of claim 1, wherein the step of magnifying comprises the step of magnifying the thumbnail image without opening the document.

8. The method of claim 1, wherein the step of magnifying comprises the steps of:
creating a window to reveal the portion of the contents of the document; and
adjusting the size of the window.

9. The method of claim 1, wherein the thumbnail image is a reduced-size view of the document.

10. A computer program, stored on a computer-readable medium, for viewing an image of a document stored in a computer system, the computer program comprising:
logic configured to create a thumbnail image of a portion of the contents of a document;
logic configured to initiate a magnifying mode; and
logic configured to magnify the thumbnail image to reveal the portion of the contents of the document.

11. The computer program of claim 10, wherein:
the document is a text document; and
the logic configured to create a thumbnail image comprises logic configured to create a reduced-size view of a first page of the text document.

12. The computer program of claim 10, wherein the logic configured to create a thumbnail image comprises logic configured to create a thumbnail image for each of a plurality of documents.

13. The computer program of claim 10, wherein the logic configured to magnify the thumbnail image comprises logic configured to magnify the thumbnail image to reveal the portion of the contents of the document without opening the document.

14. The computer program of claim 10, wherein the logic configured to magnify the thumbnail image comprises:
logic configured to create a window revealing the portion of the contents of the document; and
logic configured to adjust the size of the window.

15. An icon configured to initiate the computer program of claim 10, wherein the icon is placed in a system tray.

16. A document manager stored on a computer-readable medium, the document manager comprising:
logic configured to access documents stored in a computer system;
logic configured to display accessible documents in a document window;
logic configured to create thumbnail images such that each thumbnail image is a view of a portion of the contents of a respective accessible document;
logic configured to initiate a magnifying mode; and
logic configured to magnify one of the thumbnail images.

17. The document manager of claim 16, wherein the accessible documents are text documents and graphic documents.

18. The document manager of claim 17, wherein the logic configured to create thumbnail images comprises logic configured to create a reduced-size view of a first page of each of the text documents and to create a reduced-size view of the graphic documents.

19. The document manager of claim 16, wherein the logic configured to initiate the magnifying mode further comprises logic configured to change the shape of a mouse pointer to a magnifying glass shape.

20. The document manager of claim 19, wherein the logic configured to magnify one of the thumbnail images comprises logic configured to respond to the movement of the magnifying glass shape within the document window.

21. The document manager of claim 20, wherein the logic configured to respond to the movement of the magnifying glass shape comprises logic configured to magnify a thumbnail image over which the magnifying glass shape is superimposed.

22. A system for managing documents stored in memory, the system comprising:
means for accessing a number of related documents;
means for displaying the related documents in a document window;
means for creating thumbnail images, each thumbnail image being a view of a portion of the contents of a respective related document; and
means for magnifying one of the thumbnail images.

23. The system of claim 22, wherein the means for magnifying one of the thumbnail images comprises:
means for changing an operational mode of the system to a magnifying mode;
means for indicating that the system is operating in a magnifying mode;
means for selecting a thumbnail image; and
means for increasing the size of the selected thumbnail image.

24. The system of claim 23, wherein the means for increasing comprises:
means for producing a new window having a size greater than the size of the selected thumbnail image;
means for displaying the portion of the contents of the respective related document within the new window in a manner so as to fill the new window.

25. The system of claim 22, wherein the means for magnifying one of the thumbnail images comprises:
means for selecting a thumbnail image; and
means for increasing the size of the selected thumbnail image.
